(19) United States
(12) Patent Application Publication
(10) Pub. No.: US 2026/0247180 A1
(43) Pub. Date: Aug. 20, 2026

(54) Systems and Methods for Accelerated Network Reconnection

(71) Applicant: ZEBRA TECHNOLOGIES CORPORATION, Lincolnshire, IL (US)

(72) Inventors: Anandakumar Gopalsamy, Ronkonkoma, NY (US); Dayal Madhukar Rai, Bangalore (IN); Ambika Nagarajaiah, Bangalore (IN); Ramesh Aravind Murugamanickam, Erode (IN)

(21) Appl. No.: 18/913,170

(22) Filed: Oct. 11, 2024

(51) Int. Cl. H04W 24/08; H04W 8/00; H04W 76/10; H04W 84/12

(52) U.S. Cl. CPC H04W 24/08; H04W 8/005; H04W 76/10; H04W 84/12

(57) ABSTRACT

A method in a wireless communication device includes: obtaining (i) a primary list including a plurality of wireless communication channels, and (ii) an auxiliary list including a subset of the wireless communication channels; detecting a disconnection event from a wireless network; when a first time period has elapsed after the disconnection event, scanning the wireless communication channels of the auxiliary list; and when a second time period, the second time period being longer than the first time period, has elapsed after the disconnection event, scanning the wireless communication channels of the primary list.

### BACKGROUND

Wireless communication devices, such as mobile computers, can connect to a wireless local area network (WLAN), e.g., deployed within a facility. When a mobile computer travels outside of the coverage area of the WLAN, the mobile computer's connection to the WLAN may be lost. When the mobile computer returns to the coverage area, there may be a delay in reconnecting to the WLAN.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a diagram of a wireless communications system.

FIG. 2 is a diagram of certain internal components of a communications device in the system of FIG. 1.

FIG. 3 is a flowchart of a method of accelerated network reconnection via perimeter scans.

FIG. 4 is a diagram illustrating an example performance of block 310 of the method of FIG. 3.

FIG. 5 is a diagram illustrating example primary and auxiliary channel lists, and example scan intervals, used in the method of FIG. 3.

FIG. 6 is a diagram illustrating an example performance of block 345 of the method of FIG. 3.

FIG. 7 is a diagram illustrating an example updated auxiliary channel lists and scan intervals, used in the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method in a wireless communication device, the method including: obtaining (i) a primary list including a plurality of wireless communication channels, and (ii) an auxiliary list including a subset of the wireless communication channels; detecting a disconnection event from a wireless network; when a first time period has elapsed after the disconnection event, scanning the wireless communication channels of the auxiliary list; and when a second time period has elapsed after the disconnection event, the second time period being longer than the first time period, scanning the wireless communication channels of the primary list.

Additional examples disclosed herein are directed to a computing device, including: a communication interface; and a controller configured to: obtain (i) a primary list including a plurality of wireless communication channels, and (ii) an auxiliary list including a subset of the wireless communication channels; detect a disconnection event from a wireless network; when a first time period has elapsed after the disconnection event, scan the wireless communication channels of the auxiliary list; and when a second time period has elapsed after the disconnection event, the second time period being longer than the first time period, scan the wireless communication channels of the primary list.

Further examples disclosed herein are directed to a method in a wireless communication device, the method including: storing a primary list including a plurality of wireless communication channels; upon expiry of a primary scan interval, scanning the wireless communication channels of the primary list to detect a base station; establishing a connection with a base station using one of the plurality of wireless communication channels; and generating an auxiliary list including the wireless communication channel.

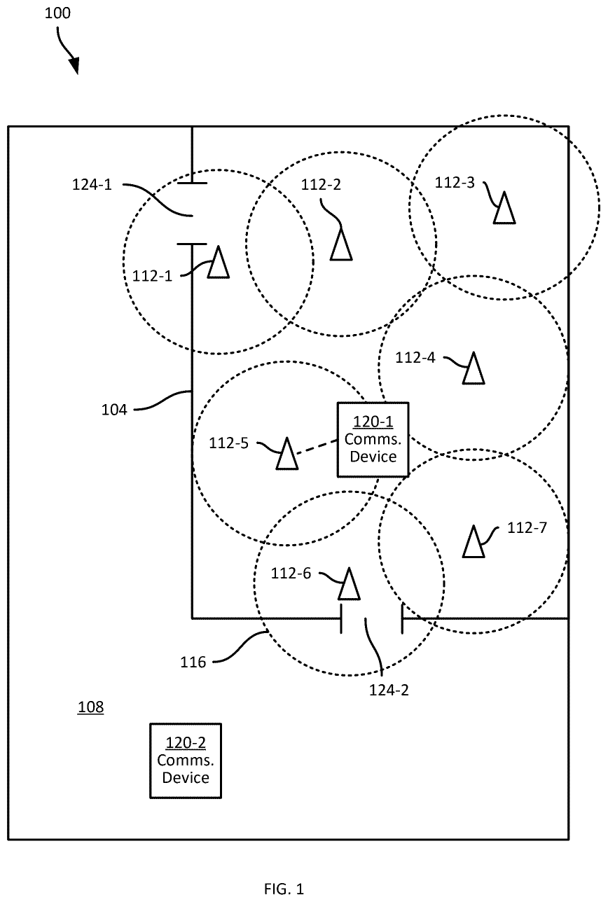

FIG. 1 is an overhead diagram of a system 100 for accelerated network reconnection. The system 100 is deployed, in this example, in a facility such as a warehouse, a manufacturing facility, a transport and logistics facility, or the like. The facility can include a building 104, and an outdoor area 108. For example, the building 104 can include an item handling facility, e.g., a cargo facility at an airport or the like, and the outdoor area 108 can include a loading area for vehicles (e.g., aircraft). Staff at the facility may be tasked, for example, with retrieving items (e.g., packages, luggage, or the like) from the building 104 and transporting the items to the area 108 for loading, and/or unloading items within the area 108 and transporting those items to the building 104. A wide variety of other tasks may also be performed at the facility, at least some of which involve travel between the building 104 and the outdoor area 108. The arrangement of the facility can also vary widely in other examples. For instance, the outdoor area 108 can be another building, or another portion of the building 104.

The system 100 includes a wireless network, such as a wireless local area network (WLAN), e.g., based on the Institute of Electrical and Electronics Engineers (IEEE) 802.11 family of standards (e.g., one or more Wi-Fi(TM) networks). In other embodiments, the system 100 can include one or more wide-area wireless networks (WWANs), such as cellular networks or the like, in addition to or instead of WLANs. The wireless network is implemented by at least one base station. In the illustrated example, the system 100 includes a WLAN implemented by a plurality of base stations (BSs) 112-1, 112-2, 112-3, 112-4, 112-5, 112-6, and 112-7, also referred to as access points (APs). The APs 112 are also referred to herein collectively as the APs 112, and generically as an AP 112. Similar nomenclature may be used for other components herein, with a reference number (e.g., “112”) followed by a hyphenated suffix (e.g., “-1”). The system 100 can include more than seven access points 112, or fewer than seven access points 112 in other examples. The APs 112 can implement a single WLAN, e.g., having a service set identifier (SSID). In other examples, the APs can be implemented as other forms of base station, e.g., gNB base stations in the context of cellular packet-switched networks.

The APs 112 each have a coverage area 116, within which wireless communication devices can establish connections with the APs 112. Although the coverage areas 116 are illustrated in FIG. 1 as having equally-sized circular footprints, it will be understood that in practice the coverage area of a given AP 112 can vary in both shape and size relative to that of other APs 112. For example, the hardware configurations (and therefore, for example, the transmission power) of the APs 112 may vary, and the extent of coverage provided by a given AP 112 may be affected by the environment the APs 112 are deployed in.

As seen in FIG. 1, the APs 112 provide coverage within the building 104 that can, but does not necessarily, extend substantially throughout the interior of the building 104. The area 108 outside the building 104, however, may have little or no coverage by the APs 112. More generally, the system 100 includes a region substantially covered by the APs 112, and another region with little or no coverage by the APs 112. As noted above, workers at the facility may travel between the building 104 and the area 108, in some cases multiple times per shift. The workers may carry mobile wireless communication devices, such as a wireless communication device 120-1 and a wireless communication device 120-2. The devices 120 may be mobile computers, smartphones, wearable computers, mobile printers, barcode scanners, tablet computers, or the like. The devices 120 can be configured to connect to the WLAN implemented by the APs 112 when in range of an AP 112. For example, the device 120-1 is shown connected to the AP 112-5. Devices 120 can roam between APs 112 as they travel within the facility. When an operator of a device 120 exits the building 104, e.g., via one or more exits/entrances 124-1, 124-2, the device 120 may disconnect from the WLAN, as the device 120 may be too far from any of the APs 112 to maintain a connection. For example, the device 120-2, shown in the outdoor area 108, is not currently connected to an AP 112. The device 120-2 may be connected to another wireless network, such as a cellular network or other suitable WAN (not shown in FIG. 1).

The performance and/or cost of a WAN connection distinct from the wireless communications service provided by the APs 112 may be suboptimal in comparison to the WLAN connection implemented by the APs 112. The devices 120 may conduct a variety of communications in the facility, e.g., including voice calls, barcode scanning operations involving communications with a server, or the like. Those communications may be faster and/or less expensive over the WLAN implemented by the APs 112 than with a cellular network or other WAN available in the outdoor area 108. Further, WAN-based communications may consume more power, draining the batteries of the devices 120 more quickly than communications over the WLAN.

When a device 120, having previously exited the building 104 via an exit 124, re-enters the building 104, or more generally, re-enters the coverage area of the WLAN, there may be a delay between when the device 120 enters a coverage area 116, and when the device 120 establishes a connection with an AP 112. For example, wireless communication devices can be configured to perform periodic scans of a plurality of wireless channels, e.g., sending probes to discover APs 112 and/or listening for beacons broadcast by the APs 112 on each of a plurality of channels defined by the communication standard(s) used within the WLAN. The devices 120 may be configured to perform such scans relatively frequently shortly after losing a connection with the WLAN, and to reduce the frequency of such scans over time. For example, once a device 120 has been in the outdoor area 108 for ten minutes, the frequency at which the device 120 performs channel scans, and may therefore discover an AP 112 to connect to, may be about 60 seconds. Thus, when the device 120 re-enters WLAN coverage, there may be a delay of up to a minute before the device 120 reconnects to the WLAN.

Increasing the frequency of such scans may reduce the reconnection delay mentioned above, but may also increase power consumption at the devices 120. The devices 120 are therefore configured, as described below, to perform two distinct types of channel scan. The scans performed by the devices 120 include a primary scan, in which a device 120 scans a primary list of channels (e.g., the 14 channels of the 2.4 GHz band of the 802.11 standards), and an auxiliary scan, in which the device 120 scans a subset of those channels. The primary scans can be performed less frequently than the auxiliary scans. Further, the auxiliary list of channels used for the auxiliary scan can correspond to the channels employed by APs 112 whose coverage areas 116 encompass one of the exits 124 to the building 104. As will be apparent to those skilled in the art, a device 120 re-entering the building 104 is most likely to enter the coverage area 116 of the AP 112-1, or of the AP 112-6, before entering the coverage areas 116 of any other AP 112. The devices 120 can therefore be configured to generate or otherwise obtain a list of wireless channels used by “perimeter” APs 112 (that is, the APs 112 mostly likely to be encountered first upon re-entering the facility). The channels used by perimeter APs 112 can then be scanned more frequently than the full channel list.

The smaller number of channels scanned during an auxiliary scan (which may also be referred to as a perimeter scan) may also reduce power consumption for a perimeter scan relative to a primary scan. In combination with a reduction in frequency of primary scans, increases in total power consumption of scanning activities may therefore be mitigated or avoided. Through execution of the channel scanning functionality described below, the devices 120 may therefore reduce delays in reconnecting to the WLAN implemented by the APs 112, while mitigating or avoiding increased power consumption resulting from more frequent channel scans.

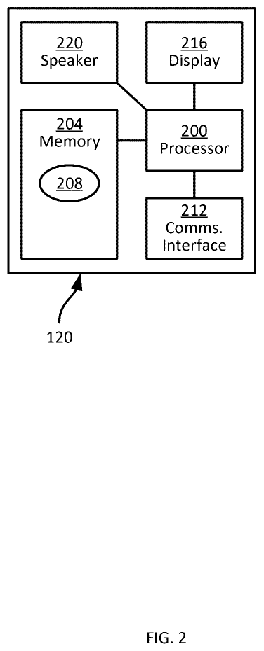

Prior to describing the channel scanning functionality implemented by the devices 120 in detail, certain internal components of an example device 120 are shown in FIG. 2. It will be understood that the form factor and specific hardware components of each device 120 may vary. As shown in FIG. 2, the device 120 includes a processor 200, such as a central processing unit (CPU), graphics processing unit (GPU), application-specific integrated circuit (ASIC), or the like, communicatively coupled with a non-transitory computer-readable storage medium such as a memory 204, e.g., a combination of volatile memory elements (e.g., random access memory (RAM)) and non-volatile memory elements (e.g., flash memory or the like).

The memory 204 stores a plurality of computer-readable instructions in the form of applications, including in the illustrated example a communications application 208, whose execution by the processor 200 configures the device 120 to establish connections with the APs 104, perform channel scanning and roaming operations, and the like.

The device 120 also includes a communications interface 212, enabling the device 120 to establish connections with networks such as the network implemented by the APs 112. The communications interface 212 can therefore include any suitable combination of transceivers, antenna elements, and corresponding control hardware enabling communications with the APs 112. In some examples, the functionality implemented by the application 208 can be implemented within the communications interface 212, e.g., in the form of firmware instructions or the like stored at the interface 212 and executed by either or both of a dedicated controller of the interface 212 and the processor 200. The processor 200, memory 204, and communications interface 212 can be implemented as components of a system-on-chip (SoC) assembly, in some examples. The device 120 can also include input devices such as a touch screen, a microphone, a camera, or the like, and output devices such as a display 216, a speaker 220, and the like.

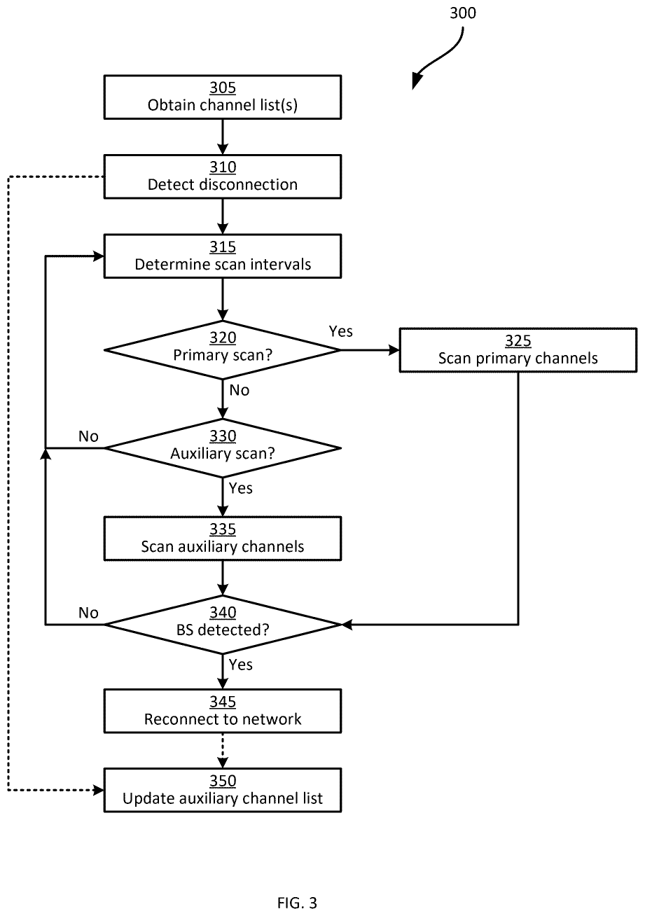

Turning to FIG. 3, a method 300 of accelerated network reconnection via perimeter channel scanning is illustrated. The method 300 is described below in conjunction with its performance by a device 120, for example via the execution of the application 208 by the processor 200 and/or a controller of the communications interface 212. As will be apparent, more than one device 120 at the facility shown in FIG. 1 can implement the method 300. In some examples, each device 120 deployed at the facility can be configured to perform the method 300.

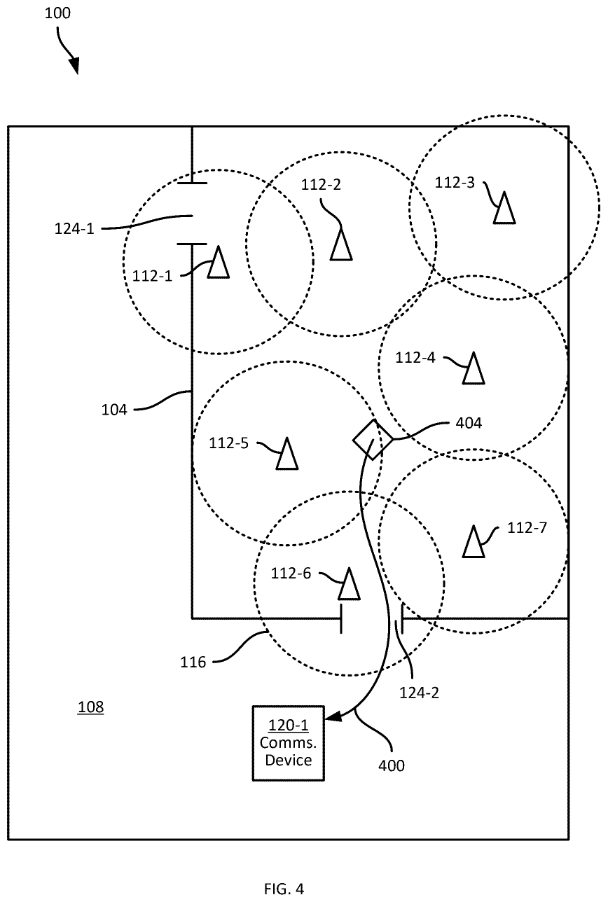

Prior to performing the method 300, the device 120 can be connected to the WLAN. For example, this instance of the method 300 may be performed by the device 120-1, which is connected to the AP 112-5 as shown in FIG. 1. As the device 120-1 moves through the building 104 (e.g., carried by an operator of the device 120-1, the device 120-1 may roam between the APs 112. For example, as shown in FIG. 4, the device 120-1 may travel along a trajectory 400 from an initial location 404, through the exit 124 into the outdoor area 108. During travel along the trajectory 400, the device 120-1 may roam from the AP 112-5, to the AP 112-6. At the current location of the device 120-1 shown in FIG. 4, however, the device 120-1 is outside the coverage area 116 of the AP 112-6, and therefore loses its connection to the WLAN.

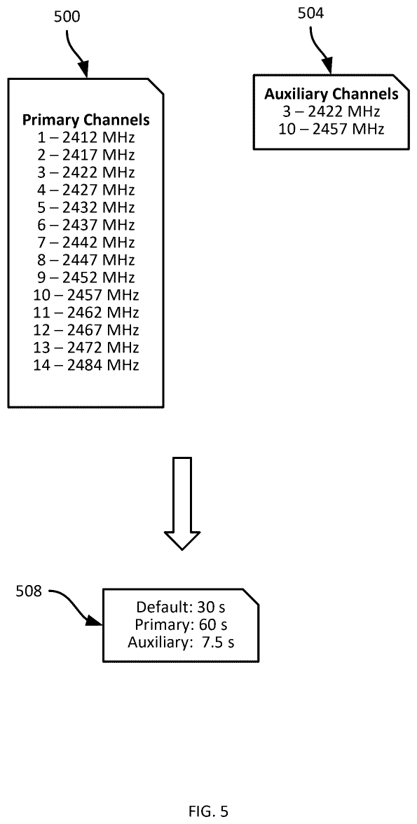

At block 305, the device 120-1 is configured to obtain at least a primary wireless channel list, including identifiers of a primary set of channels to scan. The primary list can include every available channel according to the wireless communication standard(s) implemented by the WLAN, and can be encoded in firmware at the interface 212, or stored in the memory 204. For example, as shown in FIG. 5, the device 120-1 can store a primary list 500 identifying each of the 14 channels of the 2.4 GHz band of the 802.11 standards. In some examples, the facility may implement a channel mask, and thus any device 120 deployed in the facility may be provided with a primary list 500 that omits one or more channels.

The device 120-1 also obtains, at block 305, an auxiliary list 504, which can also be referred to as a perimeter list. The auxiliary list 504 includes a subset of the channels in the list 500. That is, the channels in the auxiliary list 504 also appear in the primary list 500, but the auxiliary list 504 does not contain every channel of the primary list 500. The auxiliary list 504 can be obtained in various ways. As will be described below, the device 120-1 can update the auxiliary list 504 in response to disconnection and reconnection events. The list 504 as shown in FIG. 5 may therefore have been populated with the channel identifiers “3” and “10” during one or more previous performances of the method 300 by the device 120-1.

In other examples, the auxiliary list 504 can be maintained by network infrastructure, e.g., by one or more of the APs 112, and/or by a network controller than manages the APs 112 to implement the WLAN. For example, an administrator can configure which channels the APs 112-1 and 112-6 use, and the list 504 containing those channel identifiers can be broadcast periodically by each AP 112, or otherwise provided to the devices 120. In some examples, the APs 112-1 and 112-6 can be designated (e.g., by a network administrator) as perimeter access points (that is, APs 112 whose coverage areas 116 encompass the exits 124). The above-mentioned network controller can periodically optimize which channel(s) each AP 112 uses, e.g., to reduce interference, improve coverage, or the like. The controller can be configured, following each such optimization process, to update a centrally-maintained list of perimeter channels such that the list contains the channels currently in use by the APs 112-1 and 112-6 (or, as will be understood, any other APs 112 designated as perimeter APs 112). The centrally maintained auxiliary list can be deployed to the devices 120, e.g., in beacon frames or the like from the APs 112.

In further examples, a computing device such as a server connected to the WLAN or otherwise in at least periodic communication with the devices 120 can maintain a central auxiliary list, and can deploy the auxiliary list to the devices 120, e.g., according to a schedule and/or in response to an administrator command. In still further examples, the auxiliary list can be deployed to the devices 120 via a QR Code or other graphical indicia, configured at each device 120 via inputs of the devices 120, encoded in sound waves captured by the devices 120, or the like. In some examples, e.g., in which the devices 120 construct local auxiliary lists, the auxiliary list 504 may initially be empty.

Returning to FIG. 3, at block 310, the device 120-1 detects a disconnection, e.g., resulting from traveling outside the coverage area 116 of the AP 112-6 as shown in FIG. 4. The disconnection event detected at block 310 corresponds to a loss of communication with the WLAN. In other words, roaming operations (which disconnect from one AP 112, but connect with another AP 112 of the WLAN) are not handled as disconnection events at block 305. Manual disconnections, e.g., resulting from the device 120-1 being powered off, or put into “flight mode” or the like, are also not handled as disconnection events at block 305.

Following block 310, the device 120-1 can also update the list 504, e.g., at block 350, in addition to proceeding to block 315. For example, the device 120-1 can add the channels used by the AP 112 corresponding to the disconnect event to the list 504. For example, given that the device 120-1 lost a connection with the AP 112-6 at block 310, the device 120-1 can add the channel(s) used by the AP 112-6 to the list 504 at block 350, if those channels were not already in the list 504. In some examples, e.g., prior to the device 120-1 adding any channels to the list 504, updating the list 504 can include creating the list 504.

At block 315, e.g., in response to the disconnection event detected at block 305, the device 120-1 is configured to determine scan intervals for use in performing channel scans to reconnect with the WLAN. A scan interval, as used herein, is a period of time separate channel scans. That is, the device 120-1 is configured to perform a channel scan once per scan interval. The scan intervals determined at block 315 include a primary scan interval, and an auxiliary scan interval. In cases where the list 504 is empty, the determination of an auxiliary scan interval can be omitted until subsequent operations add one or more channel identifiers to the list 504.

The auxiliary scan interval is shorter than the primary scan interval. For example, the auxiliary scan interval can be a predetermined fraction of the primary scan interval (that is, less than one whole scan interval). In some examples, the primary scan interval and the auxiliary scan interval can be determined from a default scan interval. For example, the device 120-1 can be configured to periodically adjust the default scan interval following a disconnection event, e.g., beginning at 30 seconds, and increasing over time. Rather than perform channel scans at times corresponding directly to the default scan interval, however the device 120-1 can determine the primary scan interval from the default scan interval, and can determine the auxiliary scan interval from the primary scan interval.

In the present example, the primary scan interval is a predetermined multiple of the default scan interval. For instance, FIG. 5 illustrates a set of scan intervals 508. As shown in FIG. 5, the default scan interval at a first performance of block 315 is 30 seconds, and the primary scan interval is twice the default scan interval (e.g., 60 seconds). Various other multiples can also be used. The auxiliary scan interval can be determined based on, in this example, the primary scan interval, a number of channels identified in the primary list 500, and a number of channels identified in the auxiliary list 504. For example, the auxiliary scan interval can be determined according to the following formula:

$$ASI = ( PSI \times NAC ) / ( NAC + NPC ) \qquad ( Equation l )$$

Where ASI is the auxiliary scan interval, PSI is the primary scan interval, NAC is the number of auxiliary channels (that is, the number of channels in the list 504), and NPC is the number of primary channels (that is, the number of channels in the list 500). In the example shown in FIG. 5, the number of channels in the primary list 500 is 14, the number of channels in the list 504 is 2, and the primary scan interval is 60 s. The auxiliary scan interval is therefore 7.5 s. As will be apparent to those skilled in the art, a wide variety of other mechanisms can be used to determine the primary and auxiliary scan intervals. In the event that the list 504 is empty, the device 120 may determine

Referring again to FIG. 3, at block 315 the device 120-1 is also configured to initialize timers corresponding to the primary and auxiliary scan intervals. That is, the device 120-1 can initialize a timer set to expire after a first time period (e.g., 7.5 seconds, corresponding to the auxiliary scan interval in this example) from the disconnection event (or from the most recent expiry of the relevant timer), and a timer set to expire after a second time period (e.g., 60 seconds, corresponding to the primary scan interval in this example) from the disconnection event (or from the most recent expiry of the relevant timer).

At block 320, the device 120-1 is configured to determine whether to perform a primary channel scan. In other words, the device 120-1 is configured to determine whether the second timer above has expired. When the determination at block 320 is affirmative, the device 120-1 proceeds to block 325. At block 325, the device 120-1 performs a primary channel scan, e.g., scanning each of the channels in the list 500. When the determination at block 320 is negative, e.g., because less than 60 seconds have elapsed since the disconnection event at block 310 in this example, the device 120-1 proceeds to block 330.

At block 330, the device 120-1 is configured to determine whether to perform an auxiliary channel scan. In other words, the device 120-1 is configured to determine whether the first timer above has expired. When the determination at block 330 is negative, the device 120-1 can be configured to return to block 315, e.g., to adjust the scan intervals 508. As noted earlier, the default scan interval can increase over time, and the device 120-1 can therefore periodically (although not necessarily with every performance of block 315) increase the default scan interval. Increasing the default scan interval leads to increased primary and auxiliary scan intervals. In other examples, following a negative determination at block 330, the device 120-1 can return to block 320, retaining the scan intervals 508.

When the determination at block 330 is affirmative, the device 120-1 proceeds to block 335. At block 335, the device 120-1 is configured to perform an auxiliary scan. That is, at block 335, the device 120-1 is configured to scan the wireless channels of the auxiliary list 504, omitting any channels that appear in the primary list 500 but not in the list 504. The auxiliary scan may therefore consume less time and less power than a primary scan. In addition, the auxiliary scan may be more effectively targeted towards detecting APs 112 positioned at or near the exits 124.

Following the auxiliary scan performed at block 335, or following a primary scan performed at block 325, the device 120-1 determines, at block 340, whether a base station (e.g., an AP 112) was detected during the auxiliary scan. For example, the device 120-1 can be configured to determine whether an AP 112 was detected by scanning either or both of channels 3 and 10 in this example. The device 120-1 can further determine, when such an AP 112 is detected, whether a received signal strength indicator (RSSI) or other suitable signal quality metric associated with that AP 112 is sufficient to establish a connection (e.g., whether the RSSI exceeds a predetermined roaming threshold).

When the determination at block 340 is negative (e.g., no suitable APs 112 were detected in the most recent scan, whether a primary scan at block 325 or an auxiliary scan at block 335) the device 120-1 returns to block 315, if the timers are to be adjusted, or to block 320. Upon returning to block 315 or 320, the timers are restarted, e.g., such that the second auxiliary scan after the disconnection event is performed 7.5 seconds after then first auxiliary scan, or 15 seconds after the disconnection event.

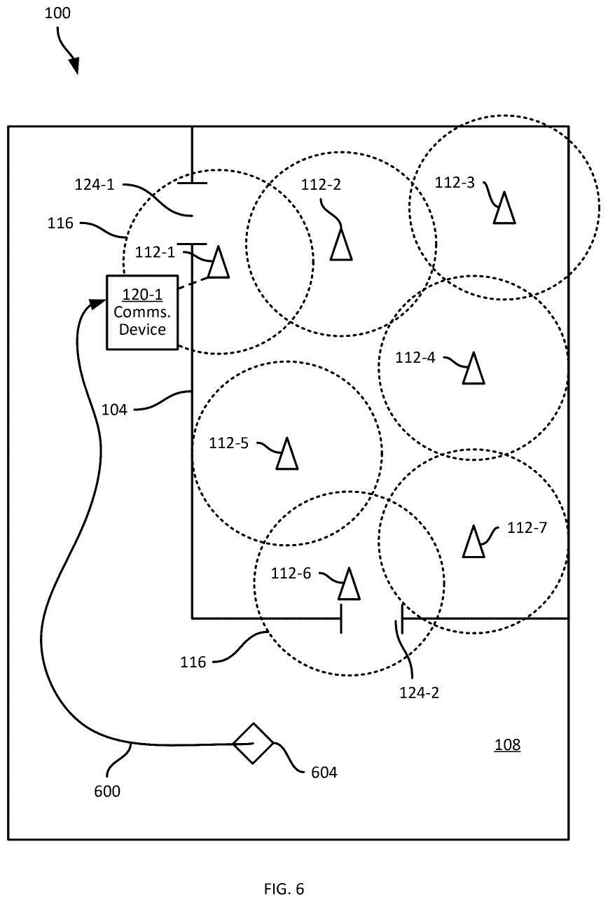

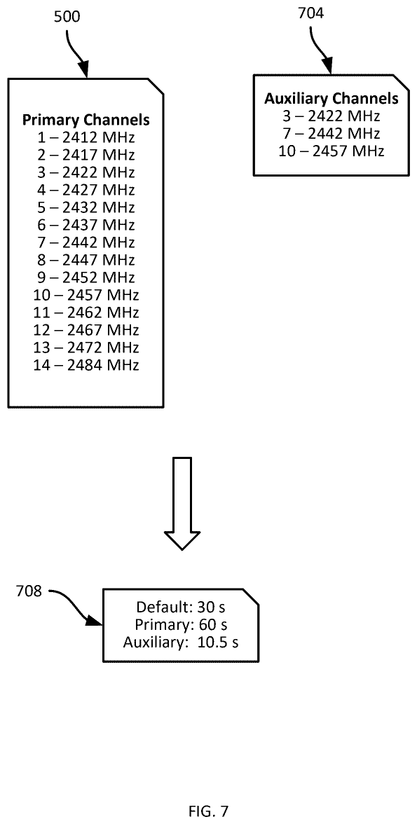

When the determination at block 340 is affirmative, the device 120-1 reconnects with the WLAN at block 345, by establishing a connection with the AP 112 detected at block 340. The device 120-1 can also proceed to block 350 to update the auxiliary channel list 504. For example, referring to FIG. 6, the device 120-1 is shown having traveled along a trajectory 600 from a previous location 604 (shown in FIG. 4), towards the exit 124 adjacent to the AP 112-1. Upon entering the coverage area 116 of the AP 112-1, the device 120-1 establishes a connection with the AP 112-1. In this example, the AP 112-1 may have been detected via a primary scan, because the AP 112-1 uses channel 7, which is not on the auxiliary list 504. In response to reconnecting to the WLAN via the AP 112-1, the device 120-1 can add the channel(s) used by the AP 112-1 to the auxiliary list 504. For example, FIG. 7 illustrates the primary list 500 and an updated auxiliary list 704, to which the channel 7 has been added. As will be apparent, updating the number of channels in the list 704 may lead to updated scan intervals 708. In particular, the increased number of channels in the list 704 may lengthen the auxiliary scan interval from 7.5 s to 10.5 s.

Updating the auxiliary channel list 504 or 704 at block 350 can also include, in some examples, pruning the auxiliary channel list, e.g., to remove channels that are likely to have been added as a result of disconnecting from a non-perimeter AP 112. For example, there may be dead spots within the building 104, and the device 120-1 may therefore lose a connection with the WLAN despite not leaving the building. Such a disconnection may lead to the channels of an internal AP 112, such as the AP 112-4, being added to the auxiliary list. Reconnecting to the WLAN after such as disconnection, e.g., to the AP 112-7, may lead to further channels being incorrectly added to the list 504 or 704. The devices 120-1 can therefore be configured to store historical disconnection and reconnection data, such as a timestamp associated with each auxiliary channel that indicates the most recent disconnection detected on that channel and the most recent reconnection on that channel. Any channels with timestamps older than a predetermined threshold (e.g., one week, although a wide variety of other thresholds can be used), may be deleted from the list 504.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method in a wireless communication device, the method comprising:
obtaining (i) a primary list including a plurality of wireless communication channels, and (ii) an auxiliary list including a subset of the wireless communication channels;
detecting a disconnection event from a wireless network;
when a first time period has elapsed after the disconnection event, scanning the wireless communication channels of the auxiliary list; and
when a second time period has elapsed after the disconnection event, the second time period being longer than the first time period, scanning the wireless communication channels of the primary list.

2. The method of claim 1, wherein obtaining the second list includes: receiving the auxiliary list from another computing device.

3. The method of claim 1, wherein obtaining the auxiliary list includes:
prior to detecting the disconnection event, detecting a previous disconnection event from a base station in the wireless network; and
updating the auxiliary list to include a channel employed by the base station.

4. The method of claim 1, further comprising:
in response to detecting the disconnection event, updating the auxiliary list to include a channel employed by a base station associated with the disconnection event.

5. The method of claim 1, further comprising:
reconnecting with a base station of the wireless network; and
updating the auxiliary list to include a channel employed by the base station.

6. The method of claim 1, further comprising:
determining the second time period based on a default scan interval; and
determining the first time period based on the first time period, a number of channels in the primary list, and a number of channels in the auxiliary list.

7. The method of claim 6, wherein the first time period is shorter than the default scan interval; and wherein the second time period is longer than the default scan interval.

8. The method of claim 1, further comprising:
determining that time elapsed since a most recent disconnection event detected in association with a channel in the subset of the wireless communication channels exceeds a threshold; and
discarding the channel from the auxiliary list.

9. A computing device, comprising:
a communication interface; and
a controller configured to:
obtain (i) a primary list including a plurality of wireless communication channels, and (ii) an auxiliary list including a subset of the wireless communication channels;
detect a disconnection event from a wireless network;
when a first time period has elapsed after the disconnection event, scan the wireless communication channels of the auxiliary list; and
when a second time period has elapsed after the disconnection event, the second time period being longer than the first time period, scan the wireless communication channels of the primary list.

10. The computing device of claim 9, wherein the controller is configured to obtain the auxiliary list by: receiving the second list from another computing device.

11. The computing device of claim 9, wherein the controller is configured to obtain the auxiliary list by:
prior to detecting the disconnection event, detecting a previous disconnection event from a base station in the wireless network; and
updating the auxiliary list to include a channel employed by the base station.

12. The computing device of claim 9, wherein the controller is configured to:
in response to detecting the disconnection event, update the auxiliary list to include a channel employed by a base station associated with the disconnection event.

13. The computing device of claim 9, wherein the controller is configured to:
reconnect with a base station of the wireless network; and
update the auxiliary list to include a channel employed by the base station.

14. The computing device of claim 9, wherein the controller is configured to:
determine the second time period based on a default scan interval; and
determine the first time period based on the first time period, a number of channels in the primary list, and a number of channels in the auxiliary list.

15. The computing device of claim 14, wherein the first time period is shorter than the default scan interval; and wherein the second time period is longer than the default scan interval.

16. The computing device of claim 9, wherein the controller is configured to:
determine that time elapsed since a most recent disconnection event detected in association with a channel in the subset of the wireless communication channels exceeds a threshold and
discard the channel from the auxiliary list.

17. A method in a wireless communication device, the method comprising:
storing a primary list including a plurality of wireless communication channels;
upon expiry of a primary scan interval, scanning the wireless communication channels of the primary list to detect a base station;
establishing a connection with a base station using one of the plurality of wireless communication channels; and
generating an auxiliary list including the wireless communication channel.

18. The method of claim 17, further comprising:
determining an auxiliary scan interval smaller than the primary scan interval, based on a number of wireless communication channels in the primary list, and a number of wireless communication channels in the auxiliary list.

19. The method of claim 18, further comprising:
detecting a disconnection event from a second base station; and
upon expiry of the auxiliary scan interval, scanning the wireless communication channels of the auxiliary list.

20. The method of claim 19, further comprising:
in response to detecting the disconnection event, updating the auxiliary list to include a further wireless communication channel employed by the second base station.
